(19) United States
(12) Patent Application Publication
(10) Pub. No.: US 2012/0317342 A1
(43) Pub. Date: Dec. 13, 2012

(54) WEAR LEVELING METHOD FOR NON-VOLATILE MEMORY

(76) Inventors: In-hwan Choi, Hwaseong-si (KR); Dong-kun Shin, Seoul (KR)

(21) Appl. No.: 13/489,804

(22) Filed: Jun. 6, 2012

(30) Foreign Application Priority Data
Jun. 8, 2011 (KR) 10-2011-0055268

(51) Int. Cl. G06F 12/02

(52) U.S. Cl. 711/103; 711/E12.008

(57) ABSTRACT

Provided is a wear leveling method for a non-volatile memory. A wear leveling method for a non-volatile memory comprising a base area in which address mapping for data access is performed on a block basis includes selecting a unit having a high wear value from among a plurality of units included in each of a plurality of blocks of the base area and mapping the selected unit of the base area to a unit included in a log area. The wear leveling method manages wear by mapping a physical address to a logical address on a block basis while performing mapping for wear leveling on a basis of a smaller unit than a block, thereby lengthening the lifespan of the memory without degrading the performance of the memory.

### CROSS-REFERENCE TO RELATED APPLICATIONS

This application claims the benefit of Korean Patent Application No. 10-2011-0055268, filed on Jun. 8, 2011, in the Korean Intellectual Property Office, the disclosure of which is incorporated herein in its entirety by reference.

### BACKGROUND

1. Field

At least some example embodiments relate to a wear leveling method for a non-volatile memory.

2. Related Art

The number of times data stored in a memory device is changed is limited because a semiconductor memory device may be worn by write and erase operations of the memory device. If the wear of a particular portion of a memory device increases due to the concentration of the write or erase operations in that portion, the performance of the memory device may degrade, and as the wear becomes serious, the data storage capability of a unit cell is completely disabled, thus affecting the lifespan of the memory device. Therefore, to lengthen the lifespan of the memory device, the wear is maintained uniform across the entire memory device, which is referred to as “wear leveling”.

During wear leveling, additional write operations may occur, which is called “write amplification”. Write amplification degrades the performance of a device and thus needs to be minimized. However, small-unit basis wear leveling for reducing write amplification may increase overhead due to address management and write management. Taking this point into account, a wear leveling method capable of lengthening the lifespan of a memory device without degrading the performance of the memory device is needed.

### SUMMARY

At least one example embodiment provides a wear leveling method that lengthens the lifespan of a memory without degrading the performance of the memory.

According to at least one example embodiment, there is provided a wear leveling method for a non-volatile memory including a base area in which address mapping for data access is performed on a block basis, the wear leveling method including selecting a unit having a high wear value from among a plurality of units included in each of a plurality of blocks of the base area, the high wear value being defined as a wear value above a reference value, and mapping the selected unit of the base area to a unit included in a log area of the non-volatile memory.

The base area may be an area in which a logical address for data access requested by a host is mapped to its corresponding physical address, and the log area may be an area having logical addresses which are not recognizable by the host.

The selecting of the unit having the high wear value may include counting a number of write operations which have been performed on on units of the base area and selecting a unit for which the counted number of write operations is greater than or equal to a reference number of write operations.

The counting of the number of writes may be performed on less than all of the plurality of units of the base area.

The counting of the number of writes may include selecting at least one block from among the plurality of blocks of the base area according to an order in which write operations are performed on the plurality of blocks and counting the number of write operations which have been performed on each unit included in the selected at least one block.

The wear leveling method may further include receiving a write request for the mapped unit of the base area, performing a write operation on the mapped unit of the log area, and counting the number of writes on the mapped unit of the log area.

The wear leveling method may further include determining whether the number of write operations on the mapped unit of the log area is greater than or equal to the reference number of write operations and if the number of write operations performed on the mapped unit of the log area is greater than or equal to the reference number of write operations, remapping the mapped unit of the base area to another unit of the log area.

The wear leveling method may further include selecting one of a plurality of blocks of the log area if there is no unit in the log area to which the unit of the base area can be mapped, moving data of a unit included in the selected block of the log area to a corresponding unit of the base area, selecting a block of the base area, and swapping the selected block of the log area with the selected block of the base area.

The selecting of one of the blocks of the log area may include selecting one of a plurality of units of the plurality of blocks in the log area according to an order in which the plurality of units in the log area are mapped to the plurality of units of the plurality of blocks in the base area; and selecting a block including the selected unit.

The selecting of one of the blocks of the log area includes selecting a block having the smallest number of units to which data has been written mapped to units of the base area. The non-volatile memory may be an over-writable memory. The non-volatile memory may be a memory in which a state of a resistance material included in a memory cell of the non-volatile memory changes according to an applied voltage value.

According to at least one example embodiment, a wear leveling method for a non-volatile memory comprising a base area and a log area, in which each of the base area and the log area includes a plurality of blocks, each including a plurality of units, may include mapping logical addresses to physical addresses on a block basis for each of the blocks included in the base area and each of the blocks included in the log area; mapping a unit among a plurality of units of the base area to a unit of the log area, if a number of write operations that have been performed on the unit is greater than or equal to a reference number; determining whether a unit of the base area corresponding to a logical address for which a data access is requested is mapped to a unit of the log area; and translating an address of the unit of the log area into a physical address corresponding to the logical address if the unit of the base area is mapped to the unit of the log area.

The wear leveling method may further include translating an address of the unit of the base area into a physical address corresponding to the logical address if the unit of the base area is not mapped to the unit of the log area.

The determining of whether the unit of the base area is mapped to the unit of the log area may include searching a mapping table in which information about the mapped unit of the base area and information about the mapped unit of the log area are written.

According to at least one example embodiment, a wear leveling method for a non-volatile memory including a base area and a log area, in which each of the base area and the log area include a plurality of logical blocks, each of the plurality of logical blocks includes a plurality of units, and the plurality of units respectively corresponds to physical units of the non-volatile memory, may include receiving a request to write data to one of the plurality of logical blocks of the base area; determining a number of write operations which have been completed on physical units that correspond to logical units of each of a selected set of logical blocks, the selected set of logical blocks being a set of logical blocks included in the base area to which data has been most recently written; and mapping one or more exceeding logical units respectively to one or more logical units included the log area, the one or more exceeding logical units each being a logical unit of the selected set of logical blocks that corresponds to a physical unit which has been written to more than a reference number of times.

A number of logical blocks included in the selected set of logical blocks may be less than a total number of logical blocks included in the base area.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram of a memory system according to at least one example embodiment;

FIG. 2 is a block diagram of a processing layer for wear leveling according to at least one example embodiment;

FIG. 3 is a flowchart of a wear leveling method according to at least one example embodiment;

FIG. 4 is a diagram schematically showing a wear leveling method according to at least one example embodiment;

FIGS. 5A and 5B show mapping tables according to at least one example embodiment;

FIGS. 6A and 6B show write number count lists for units of a base area according to at least one example embodiment;

FIGS. 7A and 7B show a unit remapping process and a mapping table update process corresponding thereto according to at least one example embodiment;

FIG. 8 is a flowchart of a process of generating a new block of a log area, according to at least one example embodiment;

FIGS. 9A and 9B are diagrams showing a process of generating a new block of a log area shown in FIG. 8 and a mapping table; and

FIG. 10 is a flowchart of a process of translating a logical address into a physical address in response to a data access request according to at least one example embodiment.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

According to at least one example embodiment, mapping of a physical address to a logical address of a device uses a block unit and mapping for wear leveling is performed on a basis of a smaller unit than a block. Wear leveling is performed such that a unit of a block on which write operations are frequently performed is mapped to a unit of a log area, which is a separate region, thereby reducing wear leveling-caused overhead and write amplification which are imposed on a memory system while achieving efficient wear leveling.

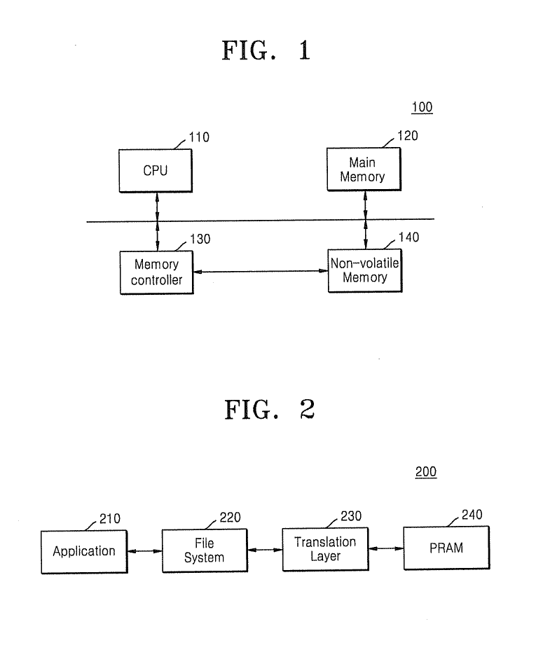

FIG. 1 is a block diagram of a memory system 100 according to at least one example embodiment.

Referring to FIG. 1, the memory system 100 according to at least one example embodiment may include a central processing unit (CPU) 110, a main memory (RAM) 120, a memory controller 130, and a non-volatile memory 140. The memory controller 130 may be implemented for wear leveling of the non-volatile memory 140 and translation of a physical address in response to a request for a logical address.

The main memory 120 shown in FIG. 1 may be, for example, a volatile memory such as static RAM (SRAM), a dynamic RAM (DRAM), or the like.

Data stored in the non-volatile memory 140 is not lost even when power supply is interrupted. The data stored in the non-volatile memory 140, after being loaded in the RAM 120, is processed by the CPU 110. The data processed by the CPU 110 is stored in the non-volatile memory 140.

FIG. 2 shows a processing layer 200 for wear leveling according to at least one example embodiment.

According to at least one example embodiment, the non-volatile memory 140 of FIG. 1 may be embodied by a programmable RAM (PRAM) 240. The PRAM 240 is a non-volatile memory which stores data by using a material that has resistance changes according to temperature and which operates with low power. In a write operation, upon application of current to a phase-change material, the phase-change material transits into a crystalline state or an amorphous state. The crystalline state or the amorphous state of the phase-change material depends on the magnitude of current flowing through the phase-change material and time the current flows. The PRAM 240 distinguishes data by a variation in the resistance of the phase-change material.

The PRAM 240 is a memory which does not require an erase-before-write operation and thus it can be overwritten. According to at least one example embodiment, the non-volatile memory 140 is not limited to a PRAM and may include, for example, an arbitrary memory which can be overwritten, including a magnetic RAM (MRAM), ferroelectric RAM (FeRAM), etc.

Wear leveling according to at least one example embodiment is performed by an application 210, a file system 220, a translation layer 230, and the PRAM 240.

The application 210 processes data in response to a user's input. The application 210 processes data and transmits a command for storing the processed data to the file system 220.

The file system 220 allocates a region where the data is to be stored, in response to the command transmitted from the application 210. The file system 220 transmits information about the data to be stored to the translation layer 230. The translation layer 230 manages the data in response to the information transmitted from the file system 220.

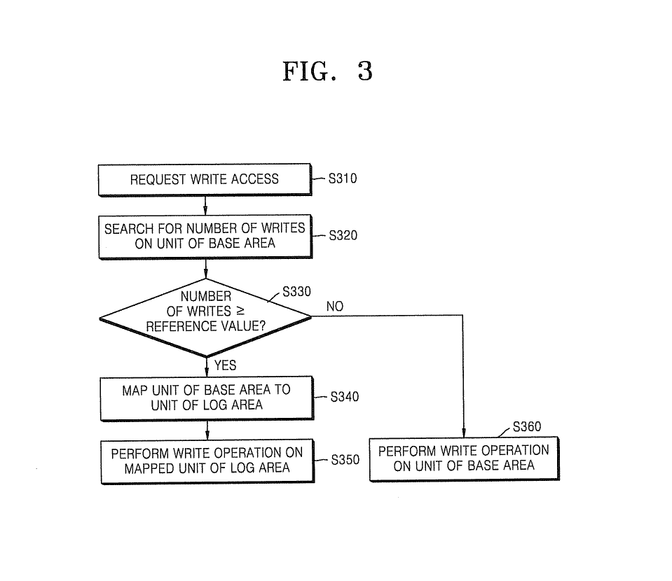

FIG. 3 is a flowchart of a wear leveling method according to at least one example embodiment.

Referring to FIG. 3, once a write access is requested in operation S310, the number of writes on a unit of a base area for which the write access is requested is searched for in operation S320. In operation S320, the translation layer 230 translates a logical address of the unit of the base area for which the write access is requested into a logical block number and a unit offset to search for the number of writes on the unit in a list where the number of writes on units of the base area is counted.

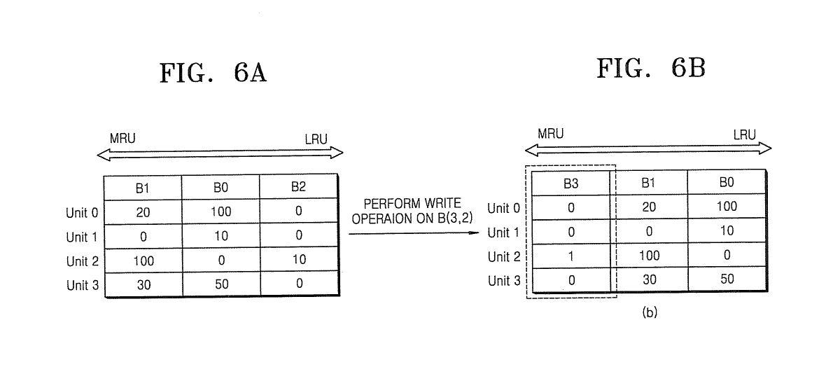

According to at least one example embodiment, to reduce overhead of the PRAM 240, the number of write operations which have been performed on units of a reference or predetermined block is deter mined, instead of the number of writes on all units. A method of counting the number of writes on the units of the base area will be described below with reference to FIG. 6.

In operation S330, A determination is made by, for example the translation layer 230, regarding whether the found number of writes on the units of the base area is greater than or equal to a reference value. The determination of whether the number of writes on the units of the base area is determining whether a unit has a higher wear value than other units. If the number of writes is greater than or equal to the reference value, such a unit is deter mined as a high-wear unit.

If the number of writes on the units of the base area is greater than or equal to the reference value in operation 330, in operation S340, the unit of the base area is mapped to a unit of a log area by, for example, the translation layer 230. In this case, address information of the unit of the base area and address information of the unit of the log area are stored in a mapping table by, for example, the translation layer 230.

In operation S350, after the unit of the base area is mapped to the unit of the log area in operation S340, a write operation is performed on the mapped unit of the log area. For example the translation layer 230 may cause data to be written to the unit of the log area in the PRAM 240. Accordingly, when the write operation with respect to the unit of the base area is requested, the write operation is performed on the mapped unit of the log area for wear leveling by referring to the address information stored in the mapping table in operation S340.

Otherwise, if the number of writes on the units of the base area is less than the reference value in operation S330, the write operation is performed on the units of the base area in operation S360. For example the translation layer 230 may cause data to be written to the unit of the base area in the PRAM 240. The number of writes being less than the reference value indicates that the unit has a low wear value such that dispersion of the write operations is unnecessary and thus, wear leveling does not have to be performed. Consequently, the write operation may be performed on the units of the base area.

In other words, when the write access is requested, is the translation layer 230, for example, determines whether the number of writes on the units of the base area is excessive or greater than desired based on whether a logical address is greater than or equal to the reference value and if the number of writes is greater than or equal to the reference value. For example, if the unit is determined as a high-wear unit, the unit is mapped to the unit of the log area, which is a separate region for wear leveling, so that the write operation is performed on the mapped unit of the log area. As such, a predetermined or reference number of write operations may be performed on the units of the base area, thereby preventing the increase of wear.

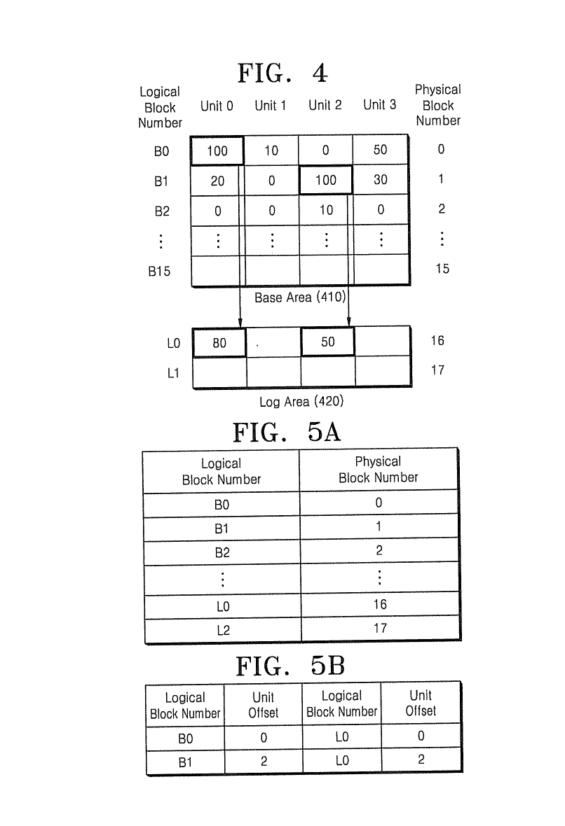

FIG. 4 is a diagram schematically showing a wear leveling method according to at least one example embodiment.

Referring to FIG. 4, the PRAM 240 includes a base area 410 and a log area 420, each of which includes a plurality of blocks, each including a plurality of units. The base area 410 is recognized by a host with a physical address corresponding to a logical address, and the size of the base area 410 is a capacity of the PRAM 240. The log area 420 is not recognizable by the host. The log area 420 is a separate area for wear leveling and is provided for dispersion of write operations (or writes) on units of the base area 410 having a high write frequency, and therefore, the size of the log area 420 may be determined according to the capacity and use purpose of the PRAM 240. Although the base area 410 and the log area 420 are divided, such a division is intended for logical area distinguishment and does not indicate physical division.

The size of a block and the size of a unit may be determined variously based on the capacity and performance of a memory. Because a block is a unit of mapping of a physical address to a logical address, the size of the block may be set taking into account the overhead of a memory system due to address mapping. The PRAM 240 is accessible word-by-word, and thus the size of a unit may be a minimum word unit.

While the base area 410 is shown as having 16 blocks, the log area 420 is shown as having 2 blocks, and each block is shown as having 4 units in FIG. 4, the number of blocks or units may vary according to the capacity of the PRAM 240, the size of a block, and the size of a unit.

Referring back to FIG. 4, blocks of the base area 410 and blocks of the log area 420 are assigned with logical block numbers and physical block numbers corresponding to the logical block numbers. The order of each unit in a block is indicated by a unit offset. A logical address of a unit may be indicated by a logical block number and a unit offset. For example, the first unit B(0,0) of the first block of the base area 410 has a logical block number “B0” and a unit offset “0”. The third unit L(0,2) of the first block of the log area 420 has a logical block number “L0” and a unit offset “2”.

In FIG. 4, a number written in a unit indicates the number of writes on the unit. For example, respective units Unit 0 through Unit 3 of a block having a logical block number “B0” in the base area 410 have different numbers of write operations “100”, “10”, “0”, and “50”. Respective units Unit 0 through Unit 3 of a block having a logical block number “B1” in the base area 410 also have different numbers of write operations “20”, “0”, “100”, and “30”. This means that even in the same block, write operations are intensively performed on a particular unit. In the example illustrated in FIG. 4, it is assumed that a reference value of the number of writes for determining whether to map a unit of the base area 410 to a unit of the log area 420 is 100. This value is only an example, and thus may be changed by a user to have any value according to the efficiency of wear leveling.

The units B(0,0) and B(1,2) have a number of writes equal to “100” which is the reference value are determined as high-wear units. Subsequently, to prevent any further write operation and prevent increase of their deviations in wear values from other units, the units B(0,0) and B(1,2) may be mapped to units L(0,0) and L(0,2) of the log area 420, respectively.

If write operations with respect to the units B(0,0) and B(1,2) of the base area 410 are requested after the units B(0,0) and B(1,2) are mapped to the units L(0,0) and L(0,2) of the log area 420, the write operations are actually performed on the mapped units L(0,0) and L(0,2) of the log area 420 and the number of writes on the units L(0,0) and L(0,2) of the log area 420 is counted. If a read command is issued, data written on the units L(0,0) and L(0,2) of the log area 420 is read. Information about the mapped units L(0,0) and L(0,2) of the log area 420 is written in mapping tables shown in FIGS. 5A and 5B.

FIGS. 5A and 5B show mapping tables according to at least one example embodiment. FIG. 5A shows a mapping table of physical blocks to logical blocks and FIG. 5B shows a mapping table including address information of units of a base region and a log region mapped to each other for wear leveling.

Referring to FIG. 5A, on the mapping table of physical blocks to logical blocks are written logical block numbers and their corresponding physical block numbers for 16 logical blocks B0 through B15 of a base area and 2 logical blocks L0 and L1 of a log area.

Referring to FIG. 5B, the mapping table has logical block numbers and unit offsets of units mapped to each other. For example, a unit of a base area, which has a logical block number B0 and a unit offset 0, is indicated by the unit B(0,0). A unit of a log area mapped to the unit B(0,0) has a logical block number L0 and a unit offset 0, and thus is the unit L(0,0). Therefore, the unit B(0,0) of the base area is mapped to the unit L(0,0) of the log area. Similarly, the unit B(1,2) of the base area is mapped to the unit L(0,2) of the log area.

The mapping table of units for wear leveling may be managed according to an order in which a unit of the base area and a unit of the log area are mapped. For example, according to the mapping table shown in FIG. 5B, the unit B(1,2) and the unit L(0,2) are mapped after the unit B(0,0) and the unit L(0,0) are mapped.

The mapping tables shown in FIGS. 5A and 5B may be referred to by the translation layer 230 when a physical address with respect to a logical address is provided. Translation of a logical address into a physical address will be described below with reference to FIG. 10.

FIGS. 6A and 6B show write number count lists for units of a base area according to at least one example embodiment.

According to at least one example embodiment, when the number of writes on a unit of a base area is counted, the number of writes on some units of the base area, instead of all units of the base area, is counted. This is because in a memory, data may not be written or read uniformly across the entire area; instead, data may be intensively written or read on a block or a unit for which a write or read command is issued once. Such a phenomenon is called locality of the memory, and thus, the number of writes on a unit on which the write operations are frequently performed is counted to select a high-wear unit.

Referring to FIGS. 6A and 6B, for blocks of a base area, the number of writes on each 3 blocks on which data is written recently in order of time is counted using a least recently used (LRU) algorithm. While the number of writes on the three blocks is counted in FIGS. 6A and 6B, this is only an example. The user may determine the number of blocks to be selected, taking into account the use purpose of the PRAM 240 and the intensity of data access. The number of blocks to be selected for counting of the number of writes on each unit is a factor which determines the efficiency of wear leveling. As the number of blocks selected increases, a deviation in wear may decrease, but overhead may increase when compared to selection of a small number of blocks.

FIG. 6A shows a list in which the number of writes on units of the base area is counted before a write operation is performed on a unit B(3,2) of the base area and FIG. 6B shows a list in which the number of writes on the units of the base area is counted after the write operation is performed on the unit B(3,2) of the base area.

Referring to FIG. 6A, a most recently used (MRU) block is a block B1 and an LRU block is a block B2. According to order of time, the block B1 is a block on which a write operation is performed last among the three blocks; the block B0 is a block on which a write operation is performed prior to the block B1; and the block B2 is a block on which a write operation is performed prior to the block B0 and thus, the write operation on the block B2 is most previously performed among the three blocks. The number of writes on each unit of each block is counted and the counted number of writes is used for determination of whether to map a unit of a base area to a unit of a log area for wear leveling. If the write operations are continuously performed on the units of the three blocks, the number of writes on the units of the three blocks would also be counted continuously.

However, the write operation may be performed on a unit of another block other than the three blocks which have been managed. Referring to FIG. 6B, once the write operation is newly performed on a unit B(3,2) of the block B3 of the base area for which the number of writes has not been counted, then counting of the number of writes on units of the block B3 starts. In this case, the MRU block is the block B3 and the LRU block is the block B0.

Because only the number of writes on units of three blocks may be counted, the number of writes on the block B2 on which the write operation is performed most previously among the three blocks B0, B1, and B2 is not counted any longer when the number of writes on the units of the block B3 on which the write operation is newly performed is counted. This is because due to locality of the memory, the write operation is not performed on the most previously written block B2 any more and the write operation is continuously performed on the newly-written block B3. Therefore, the number of writes on the block B2 does not have to be counted for wear leveling; whereas the number of writes on the block B3 needs to be counted for wear leveling because the write operation is continuously performed on the block B3.

With the method discussed above with respect to FIGS. 6A and 6B, by counting the number of writes on some units rather than all units during unit-based wear leveling; it is possible to reduce overhead of the memory system due to counting of the number of writes on units for wear leveling.

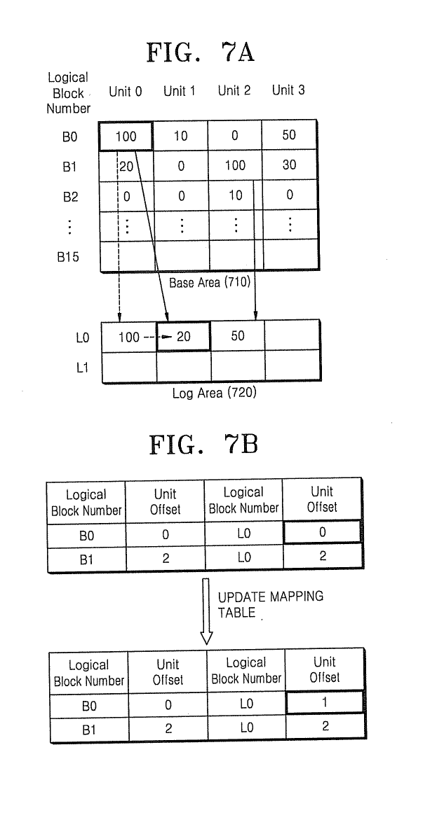

FIGS. 7A and 7B show a unit remapping process and a mapping table update process corresponding thereto according to at least one example embodiment.

According to at least one example embodiment, after a unit of the base area on which data is intensively written is mapped to a unit of the log area, a write operation continues on the unit of the log area, such that if the number of writes on the mapped unit of the log area is greater than or equal to a reference value, the unit of the base area is remapped to another unit of the log area. In this way, the write operation is prevented from being performed on the unit of the log area a more number of times than the reference value, thus managing the wear.

Referring to FIG. 7A, when the reference value is 100, the unit B(0,0) of the base area, which has the number of writes “100”, is mapped to the unit L(0,0) of the log area and then remapped to the unit L(0,1) of the log area. When the unit B(0,0) of the base area is mapped to the unit L(0,0) of the log area, if a write operation on the unit B(0,0) of the base area is requested, the write operation is performed on the mapped unit L(0,0) of the log area and the number of writes on the unit L(0,0) of the log area is counted. The write operation is performed continuously and the number of writes on the mapped unit L(0,0) of the log area becomes greater than or equal to the reference value 100, such that the unit B(0,0) of the base area is remapped to another unit L(0,1) of the log area. Thereafter, if a write operation on the unit B(0,0) of the base area is requested, the write operation is performed on the remapped unit L(0,1) of the log area and the number of writes on the remapped unit L(0,1) of the log area is counted.

FIG. 7B shows that a mapping table is updated according to remapping shown in FIG. 7A. Referring to FIG. 7B, the unit B(0,0) of the base area is mapped to the unit L(0,0) of the log area in the mapping table before update. Thereafter, in the mapping table, the unit offset of the unit L(0,0) of the log area to which the unit B(0,0) of the base area is mapped is updated from 0 to 1. This means that the unit B(0,0) of the base area is remapped to another unit L(0,1) of the log area.

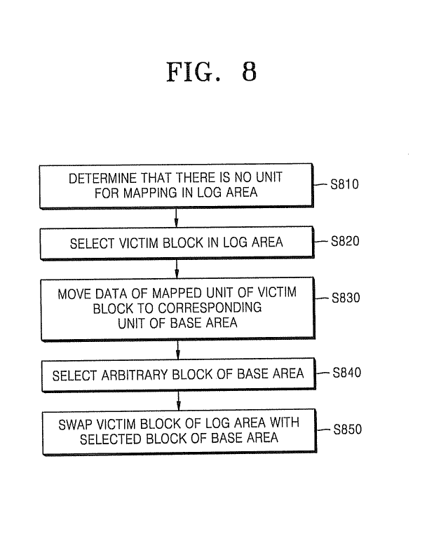

FIG. 8 is a flowchart of a process of generating a new block of a log area, according to at least one example embodiment.

According to at least one example embodiment, if there is no unit in the log area, which can be mapped to the unit of the base area, a block of the base area and a block of the log area may be swapped to generate a new block of the log area. The block of the log area is a block which includes frequently-written units mapped to units of the base area, such that the block of the log area has a high wear value. On the other hand, the block of the base area has a small number of writes on its units, and thus has a lower wear value than the block of the log area. Therefore, if there is no unit in the log area to which a unit of the base area can be mapped, the high-wear block of the log area is swapped with the low-wear block of the base area to generate a new block of the log area.

Referring to FIG. 8, it is determined that there is no unit in the log area to which a unit of the base area is to be mapped in operation S810. This means that there is no unit in the log area to which the unit of the base area can be newly mapped for wear leveling.

In operation S820, one block among blocks of the log area is selected. This block is referred to as a victim block. According to at least one example embodiment, the victim block may be a block including the smallest number of units that are either mapped to units of the base area or have not yet been mapped to any units in the base area.

In operation S830, data of a mapped unit of the victim block is moved to the corresponding unit of the base area. Thereafter, an arbitrary block of the base area is selected in operation S840 and the selected block of the base area is swapped with the victim block of the log area in operation S850. That is, if there is no unit to which a unit of the base area is mapped in the log area, a block of the log area is selected to be swapped with an arbitrary block of the base area, thus generating a new block of the log area.

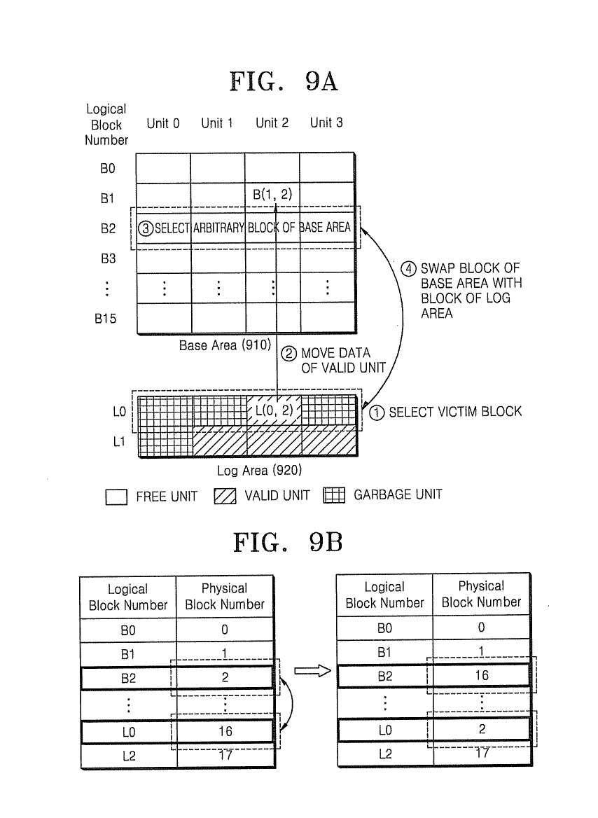

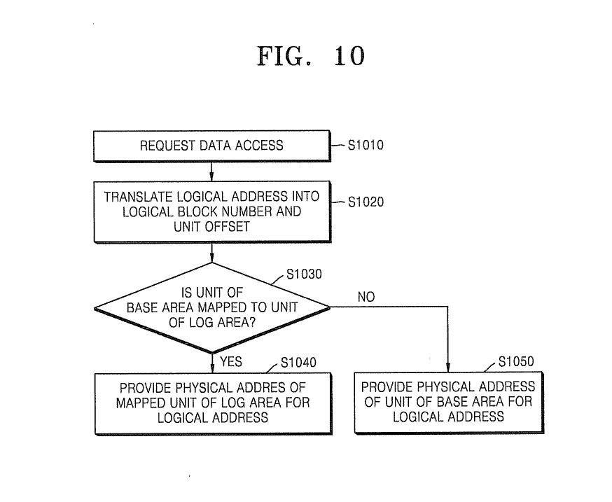

FIGS. 9A and 9B are diagrams showing the process of generating a new block of a log area shown in FIG. 8 and a mapping table, respectively.

Referring to FIG. 9A, units of the log area may be divided into free units, valid units, and garbage units. The free units are units which have not ever been mapped to units of the base area and are not currently mapped to units of the base area. The valid units are units which are mapped and currently used, and the garbage units are units which have been mapped to units of the base area and used and are not currently used because the mapped units of the base area are mapped to other units of the log area.

In FIG. 9A, L(0,0), L(0,1), L(0,3), and L(1,0) are garbage units, and L(0,2), L(1,1), L(1,2), and L(1,3) are valid units which are currently mapped and used. Because there is no free unit in the log area, there is no unit to which a unit of the base area can be mapped. Therefore, a new block of the log area is required.

According to at least one example embodiment, the number of valid or free units in the block L0 of the log area is smallest, the block L0 is selected as the victim block. Data of the selected valid unit L(0,2) of the log area is moved to the corresponding unit B(1,2) of the base area.

Next, as a block to be swapped with the victim block of the log area, the third block B2 of the base area is selected. The selected block B2 of the base area and the victim block L0 of the log area are swapped with each other. Swapping between the two blocks is performed by exchanging physical block numbers with respect to logical blocks and overwriting data stored in a physical block corresponding to the block B2 of the base area on a corresponding physical block.

As the block of the log area and the block of the base area are swapped with each other, a mapping table of physical blocks with respect to logical blocks has to be updated. Referring to FIG. 9B, as the block B2 of the base area and the block L0 of the log area are swapped with each other in FIG. 9A, a physical block number of a logical block number B2 is changed from 2 to 16 and a physical block number of a logical block number L0 is changed from 16 to 2 in the mapping table of physical blocks with respect to logical blocks.

According to at least one example embodiment, the victim block may be a block including the least recently mapped unit. The amount of time since the least recently mapped unit has been mapped may indicate that a probability of an access request for the unit is lower than other subsequently, or more recently, mapped units. Therefore, referring to the mapping table shown in FIG. 5B, the unit which is least recently mapped in order of time is selected from among mapped units of the log area, and the block of the log area including the most previously mapped unit may be selected as the victim block.

FIG. 10 is a flowchart of a process of translating a logical address into a physical address in a memory to which a wear leveling method according to at least one example embodiment is applied.

Referring to FIG. 10, once an access request for a logical address is generated in operation S1010 by, for example the application 210, the logical address for the access is translated into a logical block number and a unit offset by, for example the translation layer 230, in operation S1020. The logical block number indicates a block of the base area.

Next, it is determined, by for example the translation layer 230, whether a unit of the base area corresponding to the translated address is mapped to a unit of the log area in operation S1030. Such a determination is performed by searching the mapping table, for example in the manner discussed above with reference to FIG. 5B, including mapping information between units of the base area and units of the log area, by using the logical block number and the unit offset.

If it is determined that the unit of the base area is mapped to the unit of the log area in operation S1030 by, for example, the translation layer 230, a physical address of the mapped unit of the log area is provided as a physical address in response to the access request in operation S1040 by, for example, the translation layer 230. A physical block number corresponding to the logical block number of the unit of the log area written in the mapping table (see FIG. 5A) and the unit offset are translated into the physical address by, for example, the translation layer 230.

Otherwise, if it is determined that the unit of the base area is not mapped to the unit of the log area in operation S1030 by, for example, the translation layer 230, a physical address of the unit of the base area is provided as a physical address corresponding to the access-requested logical address in operation S1050 by, for example, the translation layer 230.

In other words, if the unit of the base area is mapped to the unit of the log area for wear leveling, once access to the unit of the base area is requested, the physical address of the mapped unit of the log area is provided as described above, such that the unit of the log area is accessed.

As can be appreciated from the foregoing description, by using a wear leveling method according to at least one example embodiment in which the number of writes on frequently written units of a block is counted and a unit written a more number of times than or equal number of times to a reference value is mapped to a unit of a separate area, the lifespan of a memory can be lengthened without degrading the performance of the memory.

A memory to which the wear leveling method according to at least one example embodiment may be mounted by using various forms of packages, such as a package on package (PoP), ball grid arrays (BGAs), chip scale packages (CSPs), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flat pack (TQFP), a small outline (SOIC), a shrink small outline package (SSOP), a thin small outline (TSOP), a thin quad flat pack (TQFP), a system in package (SIP), a multi chip package (MCP), a wafer-level fabricated package (WFP), a wafer-level processed stack package (WSP), etc.

The memory according to at least one example embodiment may be applied to a solid state disk (SSD) drive. Recently, an SSD drive expected to replace a hard disk drive (HDD) is in the spotlight in the next-generation memory market. The SSD drive has a higher speed and is strong against an external shock and also has low power consumption, when compared to the mechanically operating HDD. The memory according to at least one example embodiment may also be used as a mobile storage device. For example, the memory according to at least one example embodiment may be used as a storage device in an MP3 player, a digital camera, a personal digital assistant (PDA), an e-Book, and so forth. The memory may also be used as a storage device in a digital TV, a computer, etc.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A wear leveling method for a non-volatile memory including a base area in which address mapping for data access is performed on a block basis, the wear leveling method comprising:
selecting a unit having a high wear value from among a plurality of units included in each of a plurality of blocks of the base area, the high wear value being defined as a wear value above a reference wear value; and
mapping the selected unit of the base area to a unit included in a log area of the non-volatile memory.

2. The wear leveling method of claim 1, wherein the base area is an area in which a logical address for data access requested by a host is mapped to a corresponding physical address, and the log area is an area having logical addresses which are not recognizable by the host.

3. The wear leveling method of claim 1, wherein the selecting of the unit having the high wear value includes,
counting a number of write operations which have been performed on units of the base area; and
selecting a unit for which the counted number of write operations is greater than or equal to a reference number of write operations.

4. The wear leveling method of claim 3, wherein the counting of the number of writes is performed on less than all of the plurality of units of the base area.

5. The wear leveling method of claim 4, wherein the counting of the number of writes includes,
selecting at least one block from among the plurality of blocks of the base area according to an order in which write operations are performed on the plurality of blocks; and
counting a number of write operations which have been performed on each unit included in the selected at least one block.

6. The wear leveling method of claim 1, further comprising:
receiving a write request for the mapped unit of the base area;
performing a write operation on the mapped unit of the log area; and
counting a number of write operations which have been performed on the mapped unit of the log area.

7. The wear leveling method of claim 6, further comprising:
determining whether the number of write operations on the mapped unit of the log area is greater than or equal to the reference number of write operations; and
if the number of write operations performed on the mapped unit of the log area is greater than or equal to the reference number of write operations, remapping the mapped unit of the base area to another unit of the log area.

8. The wear leveling method of claim 1, further comprising:
selecting one of a plurality of blocks of the log area if there is no unit in the log area to which the unit of the base area can be mapped;
moving data of a unit included in the selected block of the log area to a corresponding unit of the base area;
selecting a block of the base area; and
swapping the selected block of the log area with the selected block of the base area.

9. The wear leveling method of claim 8, wherein the selecting of one of the blocks of the log area includes
selecting one of a plurality of units of the plurality of blocks in the log area according to an order in which the plurality of units in the log area are mapped to the plurality of units of the plurality of blocks in the base area; and
selecting a block including the selected unit.

10. The wear leveling method of claim 8, wherein the selecting of one of the blocks of the log area includes selecting a block having the smallest number of units to which data has been written mapped to units of the base area.

11. The wear leveling method of claim 1, wherein the non-volatile memory is an over-writable memory.

12. The wear leveling method of claim 1, wherein the non-volatile memory is a memory in which a state of a resistance material included in a memory cell of the non-volatile memory changes according to an applied voltage value.

13. A wear leveling method for a non-volatile memory comprising a base area and a log area, in which each of the base area and the log area includes a plurality of blocks, each including a plurality of units, the wear leveling method comprising:
mapping logical addresses to physical addresses on a block basis for each of the blocks included in the base area and each of the blocks included in the log area;
mapping a unit among a plurality of units of the base area to a unit of the log area, if a number of write operations that have been performed on the unit is greater than or equal to a reference number;
determining whether a unit of the base area corresponding to a logical address for which a data access is requested is mapped to a unit of the log area; and
translating an address of the unit of the log area into a physical address corresponding to the logical address if the unit of the base area is mapped to the unit of the log area.

14. The wear leveling method of claim 13, further comprising:
translating an address of the unit of the base area into a physical address corresponding to the logical address if the unit of the base area is not mapped to the unit of the log area.

15. The wear leveling method of claim 13, wherein the determining of whether the unit of the base area is mapped to the unit of the log area includes searching a mapping table in which information about the mapped unit of the base area and information about the mapped unit of the log area are written.

16. A wear leveling method for a non-volatile memory including a base area and a log area, in which each of the base area and the log area include a plurality of blocks, each of the plurality of blocks including a plurality of units, the wear leveling method comprising:
receiving a request to write data to one of the plurality of blocks of the base area;
determining a number of write operations which have been completed on units that correspond to units of each of a selected set of blocks, the selected set of blocks being a set of blocks including units to which data has been most recently written in the base area; and
mapping one or more exceeding units respectively to one or more units included in the log area, the one or more exceeding units each being a unit of the selected set of blocks and each being a unit which has been written to more than a reference number of times.

17. The method of claim 16, wherein a number of blocks included in the selected set of blocks is less than a total number of logical blocks included in the base area.
